(19) United States
(12) Patent Application Publication
(10) Pub. No.: US 2024/0086933 A1
(43) Pub. Date: Mar. 14, 2024

(54) MERCHANT CASH ADVANCE CHARGEBACK PROTECTION PROGRAM

(71) Applicant: Financial Protection Services, Columbus, GA (US)

(72) Inventor: Scott Clymo, Columbus, GA (US)

(21) Appl. No.: 18/124,377

(22) Filed: Mar. 21, 2023

Related U.S. Application Data
(60) Provisional application No. 63/322,097, filed on Mar. 21, 2022.

(51) Int. Cl. G06Q 20/42; G06Q 20/10

(52) U.S. Cl. CPC G06Q 20/42; G06Q 20/102

(57) ABSTRACT

A method and a computer program that provides a merchant with access to short-term funding based on a debt event associated with transaction-related charges. An enhanced merchant cash advance (EMCA) module enables a merchant servicer and the merchant to enter into an agreement by which the servicer provides card payment processing services and the merchant enrolls in an MCA program to reduce the servicer's risk of liability. The EMCA triggers a pre-authorized MCA from a funder in response to an insufficient funds or overdraft alert caused by a service fee or chargeback payment. The EMCA enables the MCA to be automatically repaid by taking a percentage of transaction receivables until a payback amount, which includes a flat fee, is received by the servicer on behalf of the funder. The funder can offer greater business funding, as well as a commission to the servicer, if the merchant qualifies for further funding.

### FIELD OF THE INVENTION

The present invention relates generally to monetary transaction processing, and more particularly, to merchant service fees for transaction processing.

### BACKGROUND OF THE INVENTION

Most businesses today accept credit cards from customers paying for products and services. These businesses have to pay servicing fees to merchant service companies for processing these transactions and depositing payment into a business checking account. These fees are collected by direct Automated Clearing House (ACH) debit at the beginning of a month that follows the previous month's transactions. On average, around 3% of the fees owed to the merchant service company will bounce each month for “insufficient funds” due to various reasons. In addition, businesses that accept credit cards from customers will also incur chargebacks when a customer disputes the charge on a card with their issuing bank for a number of reasons, such as not getting the product or service delivered as promised, or not recognizing the charge, or some other reason. On average, about 2% of businesses incur chargebacks each month. The merchant service company is liable for these chargebacks if the merchant service company does not collect the funds from the business whose customer disputed the transaction.

When service fees bounce, the merchant service company may have no choice but to go after the merchant to collect the funds. The merchant service company may end up having to shut down the merchant account of the particular client/merchant if that merchant is unable to pay. As a result, the merchant service company loses a client that at some point was a source of revenue. To lose a client would also mean that the merchant service company was unable to capitalize on money spent to obtain that client account, in terms of commissions paid and advertising expenses, as well as for providing the personnel needed to set up and service the account.

In addition to a loss of revenue from unpaid service fees, the merchant service company may also have to pay chargebacks when a customer disputes and causes a previous payment for a purchase to be reversed. The merchant service company is on the hook for chargeback payments and has to pay chargebacks, even if there is a delay in collecting payment from the merchant.

An occasional inability to pay service fees or chargebacks may cause a merchant to lose business/revenue due to a loss of card processing services, or to endure even greater struggles to keep their business alive. The merchant could eventually face a situation in which all future credit card transactions associated with their merchant service account are held by the merchant service company until money owed is paid. Unfortunately, these circumstances can cause the merchant to go out of business.

When a merchant goes out of business, the merchant and the business can get listed on a terminated merchant file (TMF) if the merchant gets shut down or owes money to a merchant service company. Being listed on the TMF makes it difficult for a merchant to open another account even if the merchant starts a new company that is not related to the old company. Because all merchant service companies can use this file to run a check of the merchant and the business to determine whether there is a match, the merchant may have to resort to processing credit cards with a relatively expensive off-shore account or by having a large reserve of funds set up.

Similar to payday advances provided to individuals through a cash advance company, a Merchant Cash Advance (MCA) is money advanced as a micro-loan, and/or made available to business owners for a fixed maximum term. Just as individuals are able to use payday cash advances according to their discretion, business owners, vendors, and merchants can use these micro-loan MCAs as business capital according to the specific needs of the business. MCA companies pay a hefty price for provisioning these MCAs. In order to initiate an MCA, MCA companies currently spend substantial amounts of money, such as from $300 to $1,500, in marketing and advertising costs per funded deal. In addition, these companies pay a substantial portion of profits on commissions, which are often paid upfront to a sales rep that handles the MCA.

### SUMMARY OF THE INVENTION

The present invention is directed to a method, a system, and a computer program product that provide a merchant with access to short-term (approximately 2 weeks), micro-loan funding based on a debt event associated with transaction-related charges. An Enhanced Merchant Cash Advance (EMCA) system enables a merchant servicer and the merchant to enter into an agreement by which the servicer provides card payment processing services and the merchant enrolls in an MCA program to reduce the servicer's risk of liability. The EMCA system automatically triggers a pre-authorized MCA from a funder in response to an insufficient funds or overdraft alert caused by a service fee or chargeback payment. The EMCA system enables the MCA to be automatically repaid by taking a percentage of transaction receivables until a payback amount (which includes a flat service fee), is received by the servicer on behalf of the funder. The funder can offer greater business funding, as well as a commission to the servicer if the merchant qualifies for further funding.

According to one or more aspects, the EMCA system enables funds to be automatically sent to the merchant servicer to cover an unpaid/bounced amount for service fees and/or the chargeback amount, as well as a commission and/or other share in profits for facilitating the advance of funds.

According to one or more aspects, the EMCA system triggers a pre-authorized MCA from a funder in response to an insufficient funds or overdraft alert caused by business' or merchant's bank account that overdrafts, that is about to overdraft, or that is low on funds.

According to one or more aspects, the EMCA system enables a business or merchant to request an MCA (which may be pre-authorized) from a Funder in response to an “insufficient funds” notice or overdraft alert caused by business' or merchant's bank account that: (1) overdrafts, (2) that is about to overdraft, or (3) that is low on funds, and with (4) an option for the business or merchant to include in the request an amount of funds above the amount of insufficient funds, overdraft, or that is about to overdraft.

According to one or more aspects, the EMCA system enables the merchant servicer to automatically send merchant service statements to the Funder for a specified period, such as a most recent or last three (3) monthly statements. These statements enable the merchant to be underwritten for a much larger advance amount that can be automatically offered to the merchant.

According to one or more aspects, the EMCA system includes/utilizes one or more algorithms that incorporate underwriting guidelines. The EMCA system and/or associated algorithms utilize various default parameter values, such as certain default values/percentages, that can be used to automatically approve a merchant via an App or a link sent to the merchant. The EMCA system can enable automatic approval by linking together a number of application programming interfaces (APIs) to approve and provide funds to a business quickly and efficiently.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 illustrates a block diagram representation of an example data processing system (DPS) within which certain features of the present disclosure can be implemented, according to one or more embodiments;

FIG. 2 illustrates a computer network in which primary entities associated with various aspects of triggering/issuing and repaying of merchant cash advances can communicate, according to one or more embodiments of the disclosure;

FIG. 3 presents a flow chart illustrating a process of providing a merchant with access to short-term funding based on a debt event associated with transaction-related charges, according to one or more embodiments;

FIG. 4 presents a flow chart illustrating the process of issuing a pre-authorized merchant cash advance (MCA) in response to an insufficient funds alert resulting from a chargeback, according to one or more embodiments; and

FIG. 5 presents a flow chart illustrating the process of providing a qualifying merchant with a larger amount of funding in response to the triggered merchant cash advance, according to one or more embodiments.

Like reference numerals refer to like parts throughout the several views of the drawings.

### DETAILED DESCRIPTION

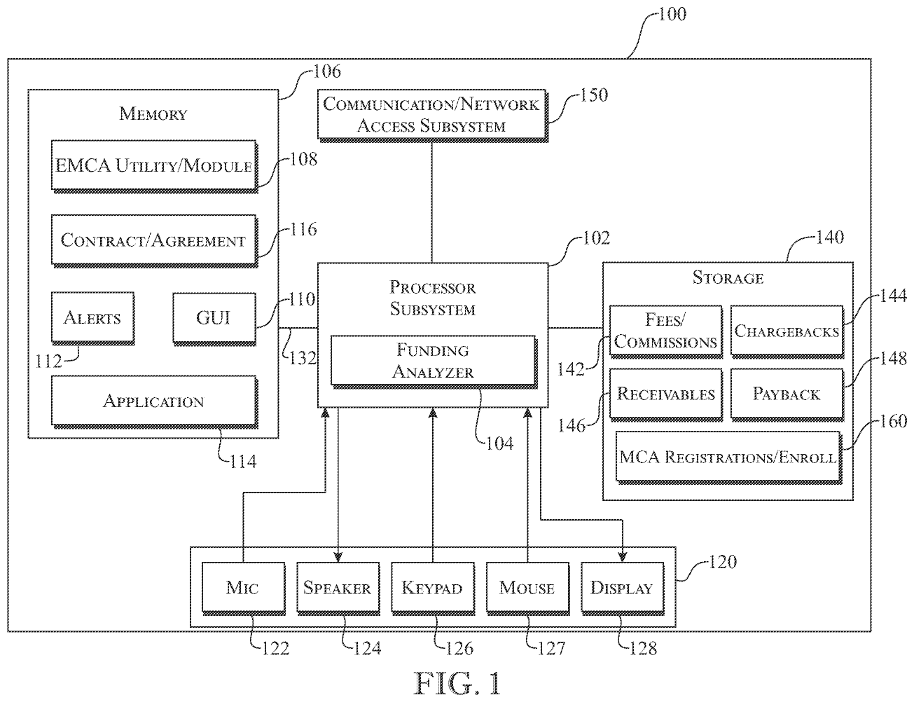

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Additionally, for purposes of description herein, except when the terms are explicitly distinguished or distinguished due to the context or when otherwise indicated, the term “account” relates to a customer record and/or account, a service account, a ledger, a customer profile, a business records account, a bank account (including checking account, savings account, money market account, and/or any type of bank account, whether for personal and/or commercial and/or business and/or institutional use), and/or the like. For example, “account(s)” in “logic for detecting a debt event including overdrafts, accounts about to overdraft, accounts low on funds, and/or accounts with insufficient funds, regardless of the type of account” includes: checking account, savings account, money market account, and/or any type of bank account, and/or promotion account, customer record and/or account, service account customer ledger, business ledger, customer profile, business profile, business records account, and/or the like. As another example, in “credit card transactions associated with their merchant service account are held by the merchant service company,” the “merchant service account” includes a customer and/or transactional account that is associated with the credit card records and/or customer records and/or accounts, credit card and/or credit card transaction records and/or ledgers and/or profiles and/or accounts, a customer record and/or account, a service account, a ledger, a customer profile, a business records account, a bank account (including checking account, savings account, money market account, and/or any type of bank account, whether for personal and/or commercial and/or business and/or institutional use), and/or the like. Likewise, for purposes of description herein, the terms “MCA,” “loan,” “line of credit,” and any other similar terms will be interpreted to include each other and being interchangeable with each other except when the terms are explicitly distinguished or distinguished due to the context. For example, “logic for enabling a financial institution (or funder) and a merchant to enter into an MCA” includes logic for entering into a loan and/or a line of credit and/or an MCA and/or a business-to-business account of the merchant with the financial institution. As another example, in the statement “an MCA is configured to be different/distinguishable from a loan since a funder is effectively buying a percentage of the merchant or business owner's future receivables at a discount,” the term “MCA” does not include loan or line of credit, but “loan” does include line of credit. Furthermore, there is no intention to be bound by any expressed or implied theory presented in the preceding Technical Field, Background, Brief Summary, or the following Detailed Description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The term “module” is interchangeable with “system”, “utility”, “program” or “sub-program”, as used herein.

Shown throughout the figures, the present invention is directed toward a system that provides a merchant with access to short-term funding based on a debt event associated with transaction-related charges.

With reference now to the figures, and beginning with FIG. 1, there is depicted a block diagram representation of an example Data Processing System (DPS), as utilized within one embodiment. DPS 100 may be a server, a digital/audio workstation, a personal computer, a portable device, such as a personal digital assistant (PDA), a smart phone, and/or other types of electronic devices that may generally be considered processing devices or computing systems/devices. As illustrated, DPS 100 comprises at least one processor subsystem 102 connected to system memory 106 via system interlink/bus 132. DPS 100 executes one or more computer programs/applications to trigger issuance/disbursement of a pre-authorized merchant cash advance (MCA) from a funder in response to an insufficient funds or overdraft alert caused by a service fee or chargeback payment, according to the present disclosure.

In one or more embodiments, data processing system 100, which is managed by processor subsystem 102, also includes communication subsystem 150, data storage subsystem 140, and input/output (I/O) subsystem 120. As shown, processor subsystem 102 includes a funding analyzer module 104 to support the data analysis functionality of DPS 100. Processor subsystem 102 executes computer program code to provide operating functionality of data processing system 100. The software and/or firmware modules have varying functionality when their corresponding program code is executed by processor subsystem 102 or secondary processing devices (not explicitly shown) within DPS 100.

As illustrated, I/O subsystem 120 includes user interface devices including output devices such as audio output device(s)/speaker 124, and display device 128. In one or more implementations, display device 128 includes touch screen functionality enabling display device to function as both an input device and an output device. In addition, I/O subsystem 120 includes input devices including microphone 122, keypad 126, mouse 127, and stylus 129 (not shown).

Processor subsystem 102 is communicatively coupled, via system bus/interlink 132, to device memory 106. In one or more embodiments, processor subsystem 102 is communicatively coupled via system interlink 132 to communication subsystem 150, data storage subsystem 140, and input/output subsystem 120. System interlink 132 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between various components.

Communication subsystem 150 may be configured to enable DPS 100 to communicate with a plurality of personal computing devices. The communication subsystem may include wired and/or wireless communication devices to facilitate networked communication. Communication subsystem 150 also includes a Network Access Module (NAM) by which DPS 100 may connect to one or more access/external networks such as the Internet or wide area network (WAN), or an internal network such as an Ethernet (local area network—LAN) or a Virtual Private Network (VPN).

In addition to the above described hardware components of DPS 100, various features of the invention are completed/supported via software (or firmware) code or logic stored within memory 106 or other storage and executed by processor subsystem 102. Thus, for example, illustrated within memory 106 are a number of software/firmware/logic components, including application 114 and other applications (not shown). In addition, memory 106 comprises an enhanced merchant cash advance (EMCA) module/logic/utility 108. Device memory 106 further includes an operating system (OS) (not shown), a firmware interface, such as basic input/output system (BIOS) or Uniform Extensible Firmware Interface (UEFI), and firmware (not shown). Device memory 106 includes a graphical user interface (GUI) 110, overdraft and/or insufficient funds alerts 112, a contract/agreement 116, and/or other computer data (not explicitly shown) used by the EMCA utility 108 and/or the Application 114.

Data storage subsystem 140 enables further storage and retrieval of data, instructions, and code. In particular, data storage subsystem 140 provides applications, program code, and stored data on nonvolatile storage that is accessible by processor subsystem 102. For example, data storage subsystem 140 can provide, for use by the EMCA utility 108, fees/commissions data 142, chargeback data 144, receivables data 146, and payback data 148. In addition, data storage subsystem 140 can provide a selection of program code and applications such as Applications 114, and other related application(s) that can be used to facilitate access to a pre-authorized MCA funds to cover the cost of transaction-related charges. These applications can be loaded into device memory 106 for execution by processor subsystem 102.

In one embodiment, the logic used in EMCA module 108 may be combined with Application 114 to provide a single executable component, collectively providing the various functions of each individual component when the corresponding combined component is activated. For simplicity, however, the EMCA logic/utility 108 is illustrated and described as a stand-alone or separate logic/firmware component, which provides specific functions, as described below.

In one embodiment, DPS 100 communicates with a software deploying server (not shown) via a network (e.g., the Internet) using communication subsystem/network access module 150. Then, EMCA utility 108 may be deployed from/on the network, via the software deploying server. With this configuration, the software deploying server performs all of the functions associated with the execution of EMCA utility 108. Accordingly, DPS 100 is not required to utilize internal computing resources of DPS 100 to execute EMCA utility 108.

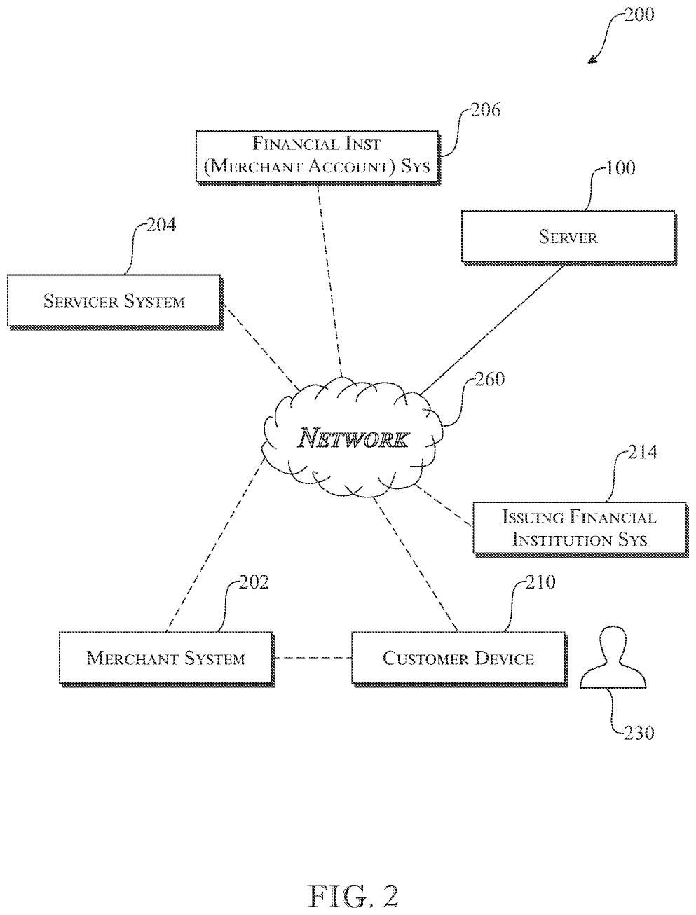

Certain of the functions supported and/or provided by the EMCA utility/module 108 are implemented as processing logic (or code) executed by processor subsystem 102 and/or other device hardware, which processing logic enables the device to implement/perform those function(s). The software code/instructions/logic provided by the EMCA system 108, which are specific to this disclosure, include: (a) logic for enabling a merchant servicer and a merchant to enter into an agreement by which the Servicer provides card payment processing services and the merchant enrolls in an MCA program; (b) logic identifying a financial institution (or funder) as a third-party beneficiary of the MCA program between the financial institution and the merchant; (c) logic for enabling a financial institution (and/or Funder) and a merchant to enter into an MCA; (d) logic for identifying a merchant servicer as a third-party beneficiary of the MCA between the funder and the merchant; (e) logic for providing an “insufficient funds” alert or an overdraft alert, as a result of a service fee payment or chargeback payment to be debited from the merchant's account; (f) logic for providing a merchant with access to a pre-authorized MCA from a Funder in response to an insufficient funds or overdraft alert; (g) logic for enabling the pre-authorized MCA to be automatically repaid by collecting a percentage of the merchant's transaction receivables until a payback amount, which includes a flat fee, is received on behalf of the funder; (h) logic for enabling the funder to offer greater business funding, as well as a commission to the servicer, if the merchant applies and qualifies for further funding; (i) logic for categorizing or treating the Funder as both the Funder and the merchant servicer, with the funder having the same access and functions and benefits from the DPS 100 and/or the EMCA utility/module 108 as a merchant servicer; (j) logic for detecting a debt event including: overdrafts, accounts about to overdraft, accounts low on funds, and/or accounts with insufficient funds, regardless of the type of account; and (k) logic for generating an alert based on a debt event occurring. According to the illustrative embodiment, when Processor subsystem 102 executes the EMCA logic/module 108, DPS 100 initiates a series of functional processes that enable the above functional features as well as additional features/functionality. These features/functionalities are described in greater detail below within the description of FIGS. 2-5.

Those of ordinary skill in the art will appreciate that the hardware components and basic configuration depicted in FIG. 1 may vary. The illustrative components within DPS 100 are not intended to be exhaustive, but rather are representative to highlight useful components that are utilized to implement the present disclosure. For example, other devices/components may be used in addition to or in place of the hardware depicted. The depicted example is not meant to imply architectural or other limitations with respect to the presently described embodiments and/or the general disclosure.

Referring now to FIG. 2, a computer network 200 for enabling primary entities/parties respectively associated with various aspects of triggering/issuing and repaying merchant cash advances to communicate, according to one or more embodiments of the disclosure. As illustrated in the computer network 200, a number of computing/electronic devices are included. These computing devices, which can be similarly configured to execute DPS 100 (see FIG. 1), include a server 100, a merchant system 202, a merchant servicer system 204, a financial institution system 206 which holds the merchant's account, and a customer device 210 corresponding to customer 230. In addition, network 200 includes an issuing financial institution system 214 which is the issuer of a credit card used by the customer 230 to engage in financial transactions. The various computing devices are connected by a network 260. The network 260 can be any of the various networks, including a LAN or a WAN/Internet, as described in FIG. 1. According to one or more aspects, the customer 230 may communicate directly with the merchant system 202 in addition to, or instead of, connecting via network 260. For example, the customer 230 may present a credit card to a point-of-sales (POS) system at a merchant's location in order to pay for goods/products and/or services. According to one or more aspects, the financial institution (or Funder) may be the same entity or a related entity (affiliate, parent, subsidiary, operator, agent, partner, associate, and/or the like) as the servicer and/or the issuing financial institution. According to one or more aspects, the merchant servicer system 204, the financial institution system 206, and/or the issuing financial institution system 214 may: (1) be the same system, (2) be partially the same system, (3) be communicatively coupled to each other, have a master-servant relationship, share resources (such as databases, data pipelines, web apps, software, ISPs, LAN, WAN, servers, computers, hardware, firewalls, authentication systems, security systems and protocols, cloud resources and systems and services, lists and information of users and customers, banking information, MCA information, the DPS 100, the EMCA utility/module 108, and/or the like), and/or the like.

Merchant system 202 includes a merchant portal (not shown). According to one or more aspects, the merchant portal is an implementation of and/or a version of the GUI 110. The merchant portal provides an interface or link for a user (for example, employee, owner, partner, member, officer, director, merchant, agent, contractor, computer with programmatic access, and/or a person and/or system and/or party authorized by the merchant), to log in and access the network 260, the server 100, and/or any other computers and systems as described above and below herein. The merchant can receive an alert, including an alert from the server 100 and/or the merchant system 202 and/or from the financial institution system 206, indicating that one or more accounts are: close to overdraft, have an overdraft, and/or have insufficient funds. According to one or more aspects, the merchant portal includes a dashboard and/or a reporting system that shows the past performance of the merchant's account and/or the merchant MCA and/or prior MCA's and/or the MCA program. The merchant system 202 obtains the past and current performance of the merchant's account and/or the merchant MCA and/or prior MCA's and/or the MCA program, and any other information through internal memory records and/or databases and/or one or more API's (or any other applicable technology) for accessing other systems, such as the server 100 and/or the financial institution system 206, the servicer system 204, the issuing financial institution system 214, and/or the like. The merchant system 202 submits to and answers requests from other systems, such as the server 100 and/or the financial institution system 206, the servicer system 204, the issuing financial institution system 214, and/or the like, through the one or more API's. Information submitted by the system 202 to other systems can include MCA information, account information (for example, account information related to customers, credit cards, transactions, the merchant, the merchant system 202, the other systems, and/or the like), and any other information, whether requested from or originating from the merchant system 202. According to one or more aspects, the merchant portal provides an interface or link to see the status of any of the merchant accounts, see the maximum MCA funding available, request funds (including automatic and/or pre-approved funds, whether before or after an MCA is triggered for funding) to be deposited into one or more merchant accounts, request a funding amount lower than the maximum available, request maximum funding available increases and/or decreases, review past MCA disbursements and/or repayments, view the status of MCA repayments including automatic repayments for the MCA funding, and/or the like. According to one or more aspects, the merchant portal provides an interface or link to see the status of any of the merchant accounts, request funds (including automatic and/or pre-approved funds, whether before or after an MCA is triggered for funding) to be deposited into one or more merchant accounts, review past MCA disbursements and/or repayments, and/or the like. According to one or more aspects, the merchant portal provides an interface or link to see credit available, execute background checks, see background check results, and/or the like.

According to one or more aspects, the merchant portal can be provided by the financial institution system 206, the merchant servicer system 204, the server 100, the merchant system 202, and/or a third-party provider through the network 260 or through the internet. The portal is configured to receive business information, personal information, bank online access credentials (user name, password, email, code, second-factor authentication, biometric authentication, digital certificate, and/or the like), MCA and/or loan application information, files or forms (PDF, Word, email forms, online forms, and/or any other format) with information via browsing and upload and/or via drag-and-drop into the portal, online forms, recording information provided by one or more users through fields and/or questions in the portal and/or in a form in the portal, and/or the like.

The computer network 200 allows contract/agreement data 116, alerts 112, fees/commissions data 142, chargeback data 144, merchant receivables data 146, payback data 148, MCA registrations/enrollments 160, and other MCA related information to be sent by the server to one or more of the various entities at the respective systems. In addition, response from the various entities can be received by the server 100. Based on the communicated/received information, the EMCA utility/module 108 can download configuration and control information to the various entity systems, respectively. According to one or more aspects, the server 100 represents a collection of servers each of which may respectively support the functions of one or more other entities within network 200.

According to one or more aspects, the merchant portal, the financial institution system 206, the merchant servicer system 204, the server 100, the merchant system 202, and/or a third-party provider of the merchant portal obtain, via one or more API's and/or other applicable technology, merchant's account information (for example, bank checking account information, the last year or the last 90 days performance information, and/or the like), credit, credit reports, credit scores, and/or the like. The merchant portal, the financial institution system 206, the merchant servicer system 204, the server 100, the merchant system 202, and/or a third-party provider of the merchant portal determine the amount of funding that a merchant can get with an MCA based on the merchant's account information, credit, credit reports, and/or credit scores, whether for immediate disbursement and/or for pre-approval, and/or whether for the maximum possible amount and/or for an amount requested by the merchant. According to one or more aspects, the determining of the amount of funding that a merchant can receive includes: underwriting, origination, sponsorship, an underwriting process, and origination process, a sponsorship process, and/or the like.

According to one or more aspects, the merchant portal can be configured to connect to and/or display a video (virtual) notary to the user via an API and/or other applicable technology. According to one or more aspects, the merchant portal is configured to provide identifying information to the video notary. The identifying information can include information identifying the user and/or the merchant, and may include credit reports, drivers license, government identification cards and/or documents, and/or the like. The merchant portal can provide part or all of the identifying information to the video notary automatically, programmatically, upon approval of the user, at the request of the user, at the request of the video notary, and/or the like. The merchant portal can connect to a local camera and microphone facing the user to show the image and likeness of the user to the video notary. The merchant portal, through a video camera, can scan documents, cards, and any other image or content in the frame of the camera, and present the image or content as identification to the video notary. The merchant portal can capture audio through the microphone at the user's side. The merchant portal is further configured to receive a notary authorization signal (NAS). The notary authorization signal indicates to the merchant portal that the user has been identified and that the user is permitted to electronically sign a document. The merchant portal is further configured to present a document for signing and/or a contract, such as an MCA or loan, to the user, and/or receive and/or record the electronic signing by a user of the document/contract, based on the notary authorization signal. The merchant portal is also configured to present a contract/agreement, such as an MCA or loan, to the user, and/or receive and/or record the electronic signing by a user of the contract, without the notary authorization signal (for example, when signing a document where a notary authorization is not required). According to one or more aspects, the merchant portal is configured to record video of the interactions between the user and the video notary and/or record information representative of legal acts and/or transactions between the user and the video notary. For example, if the video notary reviews and repeats all the terms to be captured and stored on video and disclose all terms of the funding and record on video that the merchant understands the terms and agrees to them, the merchant portal is configured to record interactions, affirmations, digital signatures, audio, video, and/or the like, as coming from the user. The financial institution system 206, the merchant servicer system 204, the server 100, the merchant system 202, and/or a third-party provider of the merchant portal obtain, via one or more API's and/or other applicable technology, can repeat audio/video capture as described above in a video notary portal. The video notary portal incorporates the features and characteristics of the merchant portal. The video notary portal is configured to receive input from a notary and to generate the notary authorization signal based on the notary input. The financial institution system 206, the merchant servicer system 204, the server 100, the merchant system 202, the merchant portal, and/or a third-party provider of the merchant portal generate and/or receive an execution signal indicating that a document, such as an MCA, has been fully signed and executed. The financial institution system 206 is configured to deposit funds to a merchant account based on at least one of the NAS execution signal and the MCA.

According to one or more aspects, an MCA is configured to be different/distinguishable from a loan since a funder is effectively buying a percentage of the merchant or business owner's future receivables at a discount. The MCA provides repayable funds and charges a flat fee for advancing money that can be collected a few weeks or months later, with the fee added to the original advance amount. Thus, the MCA does not have to use an interest rate for advancing funds, but it optionally can.

According to one or more aspects, the Funder, using funding analyzer 104 (See FIG. 1), analyzes a business' transaction activities over a selected period of time. For example, the funder may focus on a most recent three (3) months of business activity associated with a checking account. In particular, the funding analyzer may perform evaluations using a number of factors, such as total average monthly deposits and average daily balances, etc., to determine/recommend an (ideal) amount that the funder can advance to the merchant given a particular flat fee or money factor, and a specified term. According to an implementation, an average money factor rate is 1.45, and an average advance amount can be approximately $30,000.

In an example implementation, the MCA funder may provide $30,000 at a factor rate of 1.45 for a term of four (4) months. The total payback amount is determined by multiplying the amount funded by the factor rate (i.e., $30,000×1.45=$43,500, the payback amount). Based on a contract/agreement 116 between the Merchant and the Servicer, the EMCA system 108 enables a particular percentage of the merchant's credit card receivables to be collected until the total payback amount (e.g., $43,500) is received by the Funder. In an example transaction, the merchant accepts a credit card transaction for $100 and if the agreed upon percentage to be taken from each transaction is 20% then the deposits are split with $20 going to the Funder's account and $80 going to the Merchant's account. This agreed upon Funder's percentage is applied to every transaction involving the merchant's customers who pay for products/services using a credit card until the $43,500 is paid back in full. The MCA term will depend on how long it takes for the total payback to be collected, but is generally to be considered a short-term period.

According to one or more aspects, the merchant servicer can provide to business clients that accept credit card payments a merchant statement, which can be a monthly detailed statement with a breakdown of all business transactions and the fees charged. According to an aspect, when the merchant servicer chooses to participate in the MCA program, the servicer can send a notice with the merchant statement notifying the business owner that the business is being automatically enrolled in the MCA or chargeback protection program. The notice may further indicate that further details and/or details pertaining to opting out of the program can be obtained via a designated website. As a result, all existing merchants can be automatically entered into the MCA program and the merchant servicer can add an MCA program requirement or recommendation into their merchant service contract when a new merchant that accepts credit cards signs up to use the servicer to process the merchant's credit card transactions. By using this contract approach, merchants are enrolled with relatively little effort on the part of merchant servicers or MCA funders.

In addition to the fact that advertising and sales costs are generally minimized, the EMCA represents low risk funding or lending because the term is relatively short, and because the EMCA funding is paid back automatically with a percentage of future credit card transactions being split to pay back the advance. The Funder does not have to wait for a merchant to mail a payment and the advance will be paid back quickly. A low risk of default on the advance can occur if the merchant goes out of business, and in the rare cases of a default, the advances represent a relatively small loss especially when compared with the ROI from all the repaid MCAs.

According to one or more aspects, when a merchant service company (i.e., the Servicer) provides credit card transaction processing services for a merchant's business and the business' payment attempt for service fees bounce (i.e., result in non-payment) due to an insufficient funds account status, the EMCA system 108 automatically triggers a pre-authorized MCA to cover the bounced fees. According to one or more aspects, the pre-authorized MCA is a maximum amount of funds that can be accessed and used by the merchant to pay transaction-related service fees that are debited at the beginning of the month from the business owner's checking account. According to one or more related aspects, the EMCA system 108 creates the MCA that is to be issued as a subset of the maximum accessible MCA funds, based on the value of the bounced funds. According to one or more related aspects, the pre-authorized MCA is the issued MCA. The EMCA system 108 enables the issued MCA to be automatically paid back by collecting a percentage of receivables from credit card transaction payments from the merchant's customers until the issued MCA amount, plus the factor rate, is paid in full. According to one or more aspects, the EMCA system 108 automatically triggers a pre-authorized MCA to cover insufficient funds, overdrafts, and/or low funds of a merchant bank account, such as a bank checking account of the merchant. According to one or more aspects, the EMCA system 108 enables the Merchant to request funding from a pre-authorized MCA and/or a business loan, and/or request supplemental funding from a pre-authorized MCA, and/or a business loan in addition to funding resulting from the triggering of the pre-authorized MCA.

In response to the MCA being issued, the EMCA system 108 (see FIG. 1) automatically alerts the MCA funder about the MCA being issued. In addition, the EMCA system 108 enables the MCA Funder to invite (e.g., using a telephone call, text, or email) the customer to apply and seek to qualify for a much larger MCA. It may be likely that if the business is short on cash flow and have a negative account balance there may be other business needs requiring additional capital yet to be addressed. Thus, the business may likely have an interest in obtaining a larger MCA or even a line of credit or term loan depending on what the business can qualify for. As a result, the EMCA system 108 operates to provide quality business leads for a lender or MCA Funder at the very time the Merchant needs business capital. As described previously, this business capital can be provided in addition to the transaction-related MCA that was already triggered/issued. The MCA and the additional funding can be expected to provide a high return on investment (ROI) for the funder.

According to one or more aspects, the EMCA system 108 can similarly trigger issuance of an MCA when a business owner incurs a chargeback that leads to an insufficient funds account status or an overdraft status. Furthermore, the MCA funder can be alerted and can offer a larger MCA or other funding to the business if the business can qualify.

According to one or more aspects, the MCA Funder can offer the merchant servicer a small share in the profit from the MCA advance. Using the MCA advance, the merchant servicer is automatically paid the fee for which a payment previously bounced.

Additionally, instead of the merchant servicer being on the hook for chargeback payments and having to pay chargebacks even if there is a delay in collecting payment from the merchant, the MCA alleviates this financial burden and risk to the Servicer.

The MCA enables the Servicer to retain the merchants as clients longer; and instead of losing money due to a merchant's lack of funds, the Servicer can increase revenue. The MCA minimizes a risk of liability to a merchant servicer while helping to sustain merchant business operations. In addition, the Servicer can share via commissions in the larger MCAs/funding that merchants obtain when offered larger advance amounts, which ultimately provides a much larger revenue stream.

According to one or more aspects, Merchants, by having their bounced fees covered or chargebacks covered by the MCA, can better avoid losing business due to a loss of card processing services. Merchants also have an opportunity to receive additional funding, in most cases, when funding is most needed. By avoiding a situation in which all future credit card transactions associated with their merchant service account are held by the merchant servicer until money owed is paid, the MCA may help the merchant to avoid going out of business.

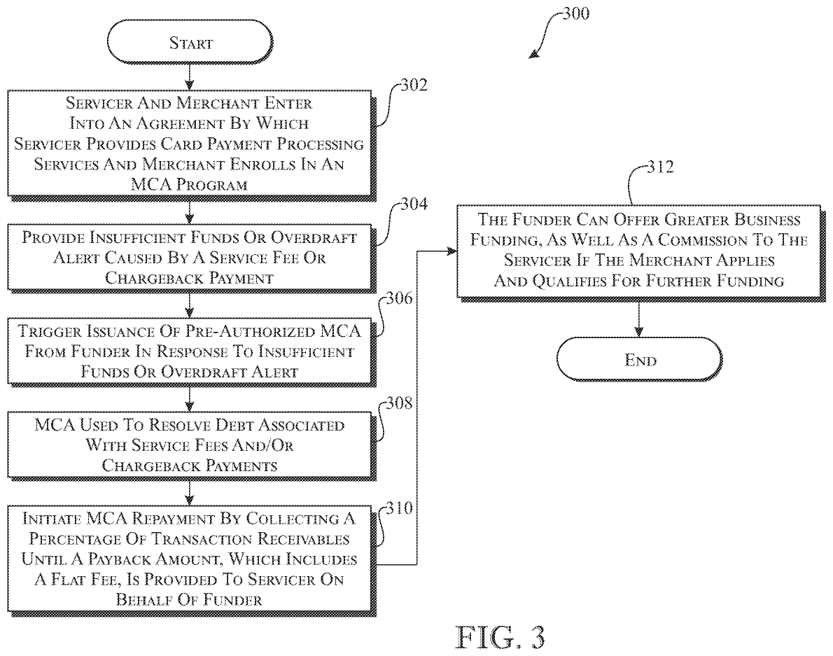

FIGS. 3-5 are flow charts illustrating various methods by which the above process of the illustrative embodiments is completed. Although the methods illustrated in FIGS. 3-5 may be described with reference to components shown in FIGS. 1-2, it should be understood that this is merely for convenience, and alternative components and/or configurations thereof can be employed when implementing the various methods. Key portions of the methods may be completed by the enhanced merchant cash advance (EMCA) module/utility 108 executing on processor subsystem 102 within DPS 100 (FIG. 1) and controlling specific operations of/on DPS 100, and the methods are thus described from the perspective of either/both the EMCA system/utility 108 and DPS 100 or other device that provides the functionality associated with one or more versions of the EMCA system/utility 108.

FIG. 3 is a flow chart illustrating an example of a process 300 of providing a merchant with access to short-term funding based on a debt event associated with transaction-related charges. The process of FIG. 3 begins at the initiator/start block and proceeds to block 302, at which the EMCA system 108 enables the merchant servicer and the merchant to enter into an agreement by which the Servicer provides card payment processing services and the Merchant enrolls in an MCA program. At block 304, the EMCA system 108 provides an “insufficient funds” alert or an overdraft alert caused by a service fee or chargeback payment.

At block 306, the EMCA system 108 triggers issuance of a pre-authorized MCA from a merchant funder in response to receipt of the insufficient funds or overdraft alert. At block 308, the EMCA system 108 uses the MCA to resolve the merchant's debt associated with service fees and/or chargeback payments.

At block 310, the EMCA system 108 initiates an MCA repayment by collecting a percentage of the merchant's transaction receivables until a payback amount, which includes a flat fee, is provided to the servicer on behalf of the funder.

According to one or more aspects, a percentage corresponding to a holdback is automatically triggered on the merchant's credit card transactions. Thus, the EMCA system 108 splits the ACH credits as the percentage for payback on all transactions for the day is sent regularly/daily to the MCA Funder company and the remaining percentage goes to the Merchant.

At block 312, the EMCA system 108 enables the Funder to offer greater business funding, as well as a commission to the Servicer if the merchant applies and qualifies for further funding. The process concludes at the end block.

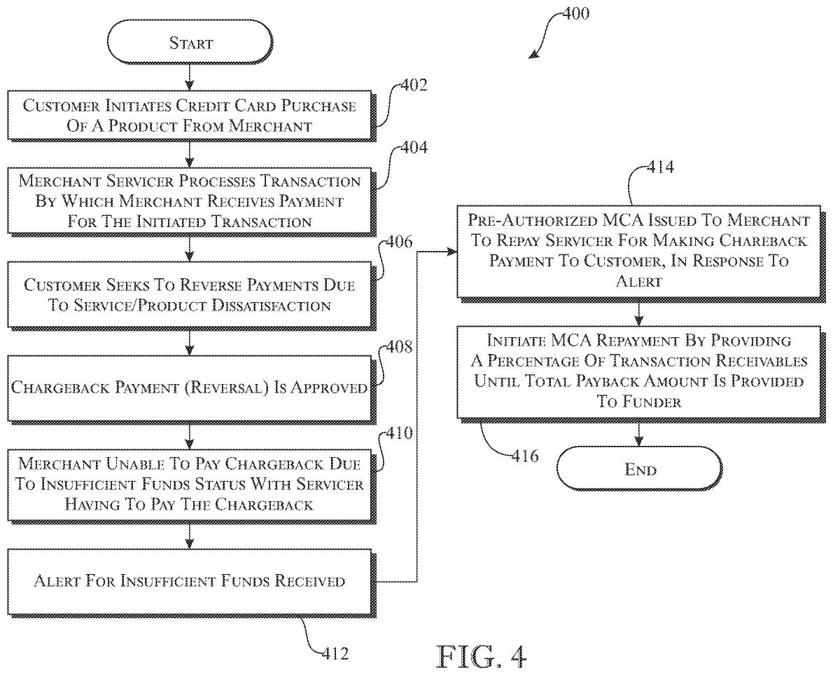

FIG. 4 is a flow chart illustrating an example of a process 400 of issuing a pre-authorized merchant cash advance (MCA) in response to receiving an “insufficient funds” alert as a result of a chargeback. The process of FIG. 4 begins at the initiator/start block and proceeds to block 402, at which the EMCA system 108 detects/determines or receives indication that a customer initiated a credit card purchase of product from Merchant. At block 404, the EMCA system 108 receives indication that the merchant servicer processes a transaction by which the merchant receives payment for the initiated transaction. At block 406, the EMCA system 108 receives indication that the customer seeks to reverse payment due to service/product dissatisfaction. At block 408, the EMCA system 108 receives indication that the chargeback payment (reversal) is approved.

At block 410, the EMCA system 108 receives indication that the merchant is unable to pay the chargeback due to an insufficient funds account status necessitating the servicer having to make the chargeback payment.

At block 412, the EMCA system 108 receives an alert for an insufficient funds status for the merchant's account. At block 414, the EMCA system 108 issues a pre-authorized MCA to the Merchant to repay the Servicer for making the chargeback payment to the customer, in response to alert.

According to one or more aspects, the EMCA system 108 enables funds to be automatically sent to the merchant servicer to cover the bounced amount for service fees and/or the chargeback amount, as well as a commission and/or other share in profits for facilitating the advance of funds.

At block 416, the EMCA system 108 initiates the MCA repayment by collecting a percentage of transaction receivables until a total payback amount is provided to the funder. The process concludes at the end block.

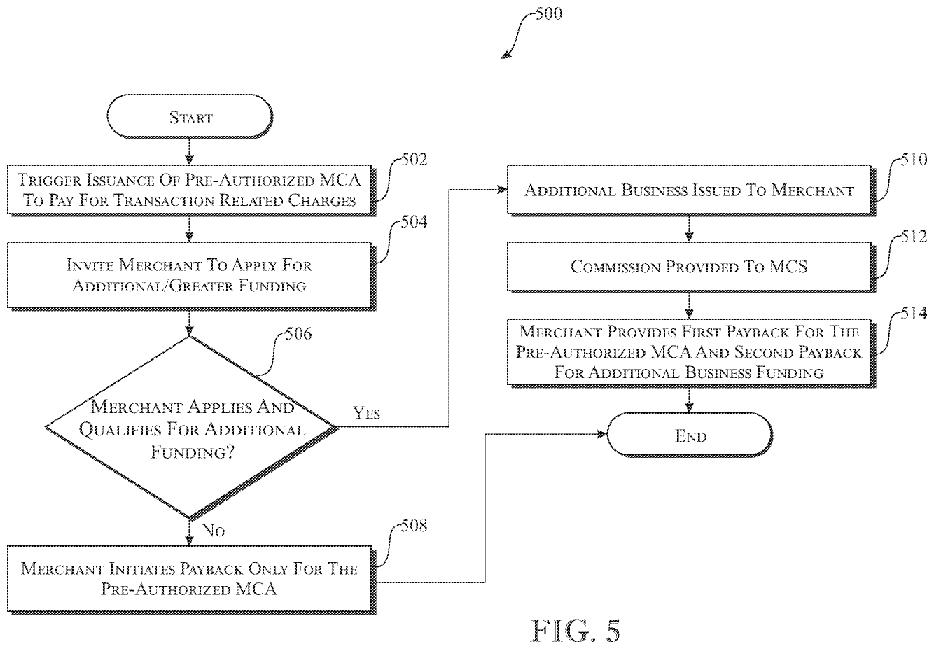

FIG. 5 is a flow chart illustrating another example of a process 500 of providing a qualifying merchant with a larger amount of funding in response to a triggered merchant cash advance. The process of FIG. 5 begins at the initiator/start block and proceeds to block 502, at which the EMCA system 108 triggers issuance of a pre-authorized MCA to pay for transaction related charges. According to an aspect, in response to an alert triggered by a debt event, such as an “insufficient funds” or overdraft account status, the MCA is automatically initiated, and the MCA funded is notified by electronic notification.

At block 504, the EMCA system 108 enables the funder to invite the merchant to apply for additional/greater funding. According to one or more aspects, the sales department of the MCA funder is notified of the MCA being triggered for an initial amount. A sales agent contacts the merchant by email, text, and/or phone and asks the merchant to provide financial statements so that the merchant can be underwritten for a larger MCA, a business term loan or line of credit. Alternatively, the merchant servicer can be allowed to automatically send merchant service statements to a Funder for a specified period, such as a most recent or last three (3) monthly statements. The statements enable the merchant to be underwritten by the Funder for a much larger advance amount to automatically be offered to the merchant without the merchant directly having to send financial statements.

At decision block 506, the EMCA system 108 determines whether the merchant applies and qualifies for additional funding. If the EMCA system 108 determines that the merchant does not qualify for additional funding, the merchant initiates payback only for the pre-authorized MCA, as shown at block 508. However, if the EMCA system 108 determines that the merchant qualifies for additional funding, the EMCA system 108 issues/disburses additional business funding to the merchant, as shown at block 510. According to one or more aspects, the merchant servicer gets disbursed a commission on the larger/additional advance or funding provided to the Merchant, as shown at block 512. According to one or more aspects, the larger/additional funding further minimizes a financial strain to the Merchant and helps to sustain business operations by providing additional capital to the Merchant to address cash flow issues and/or other business needs.

At block 514, the EMCA system 108 enables the merchant to provide a first payback for the pre-authorized MCA and a second payback for the additional business funding. According to one or more aspects, the first funding/MCA and the additional funds can be combined, and payback for a single/combined set of funds is provided. The process concludes at the end block.

According to one or more aspects, the EMCA system 108 can include/utilize one or more algorithms that incorporate underwriting guidelines. The EMCA system 108 and/or associated algorithms utilize various default parameter values, such as certain default values/percentages, that can be used to automatically approve a merchant via an App or a link sent to the merchant. The EMCA system 108 can enable automatic approval by linking together a number of application programmable interfaces (APIs) to approve and provide funds to a business quickly and efficiently.

According to one or more aspects, the DPS 100 and the EMCA system 108 operate without the direct or indirect intervention of the financial institution/Funder. The DPS 100 and the EMCA utility 108 are implemented between the merchant servicer and the Merchant. Both the Merchant and the merchant servicer provide their banking information and accounts to the EMCA system 108. The EMCA system 108 uses an API to connect to one or more banks with the banking information and accounts provided by the merchant and/or the merchant servicer. With the EMCA system 108 having the merchant's banking information and accounts, if the financial institution's API provides for programmatic MCA and/or loan applications, the EMCA 108 can use the financial institution's API to enter the Merchant into an MCA program and/or loan with the financial institution/Funder in a programmatic manner having the same features and characteristics as the above-described merchant-merchant servicer-financial institution EMCA-enabled transactions and interactions.

According to one or more aspects, the DPS 100 and the EMCA utility 108 operate without the direct or indirect intervention of the merchant servicer. The DPS 100 and the EMCA system 108 are implemented between the financial institution/Funder and the Merchant. Both the Merchant and the financial institution provide their banking information and accounts to the EMCA system 108. The EMCA system 108 uses an API to connect to one or more merchant servicers with the banking information and accounts provided by the merchant and/or the financial institution. With the EMCA system 108 having the financial institution's and the merchant's banking information and accounts, if the merchant servicer's API provides for programmatic MCA and/or loan operation (tracking customer payments to merchant, calculating fees, sending commission to the merchant servicer, and/or the like), the EMCA 108 can use the merchant servicer's API to enter the Merchant into an MCA program and/or loan with the financial institution in a programmatic manner having the same features and characteristics as the above-described merchant-merchant servicer-financial institution EMCA-enabled transactions and interactions.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An Enhanced Merchant Cash Advance (EMCA) computer system for providing quick and easy access to short-term funding for a business, the system comprising:
a network adapter that enables communication between one or more of a Merchant, a Funder, and a Merchant Servicer;
a computer memory storing an EMCA application program; and
a computer processor which executes an EMCA application that causes the system to:
(a) enroll the Merchant in an Enhanced Merchant Cash Advance (EMCA) business program by executing a contract between the Merchant and the Merchant Servicer and/or the Funder, wherein the Merchant Servicer provides card payment processing services to the Merchant, and the Merchant enrolls in an EMCA program;
(b) receive an alert as a result to a debt event associated with an account of the Merchant;
(c) trigger issuance of a pre-authorized Merchant Cash Advance (MCA) to the Merchant; and
(d) automatically collect a pre-determined percentage of merchant transaction receivables until a total owed payback amount corresponding to the MCA is received by the Funder.

2. The EMCA computer system of claim 1, wherein executing the EMCA application further comprises:
(e) inviting the Merchant to apply to the Funder for additional business funding; and
(f) in response to the Merchant qualifying for and accepting the additional business funding, providing a commission to the Merchant Servicer.

3. An Enhanced Merchant Cash Advance (EMCA) computer system for providing quick and easy access to short-term funding for a business, the system comprising:
a network adapter that enables communication between a Merchant and at least one of a Funder and a Merchant Servicer;
a memory storing an EMCA application program; and
a processor which executes the EMCA application that causes the system to:
(a) enroll the merchant in an Enhanced Merchant Cash Advance (EMCA) business program by executing a contract between the Merchant and the Merchant Servicer and/or the Funder, wherein the Merchant Servicer provides card payment processing services to the Merchant, and the Merchant enrolls in an EMCA program;
(b) receive an alert as a result to a debt event associated with an account of the Merchant;
(c) trigger issuance of a pre-authorized Merchant Cash Advance (MCA) to the Merchant; and
(d) automatically collect a specified percentage of the merchant's transaction receivables until a total owed payback amount corresponding to the MCA is received by the Funder.

4. The EMCA computer system of claim 3,
wherein an account of the Merchant comprises a bank account; and
wherein the debt event comprises one of the following:
(1) insufficient funds in the Merchant's bank account;
(2) overdraft of the Merchant's bank account;
(3) that the Merchant's bank account is about to overdraft; or
(4) that the funds in the Merchant's bank account fell below a pre-determined amount.

5. A computer-implemented method for providing quick and easy access to short-term funding for a Merchant, the method comprising:
(a) providing an Enhanced Merchant Cash Advance (EMCA) system that runs on a computer;
(b) enabling communication with one or more of a Merchant, a Funder, and a Merchant Servicer, through a network adapter;
(c) enrolling the Merchant in an Enhanced Merchant Cash Advance (EMCA) business program by executing a contract between the Merchant and the Merchant Servicer and/or the Funder;
(d) receiving an alert as a result of a debt event associated with transaction-related charges in an account of the Merchant;
(e) triggering issuance of a pre-authorized Merchant Cash Advance (MCA) to the Merchant; and
(f) automatically collecting a percentage of the merchant's transaction receivables until a total owed payback amount corresponding to the MCA is received by the Funder.

6. The method of claim 5, further comprising:
(f) inviting the Merchant to apply to the Funder for additional business funding; and
(g) in response to the Merchant qualifying for and accepting the additional business funding, providing a commission to the Merchant Servicer.

7. The method of claim 5, wherein the EMCA system enables automatic approval by linking together one or more application programming interfaces (APIs) to quickly and efficiently approve and provide funds to a Merchant.

8. The method of claim 5, wherein the EMCA system includes a data storage system that stores fees/commissions data, chargeback data, receivables data, and payback data.

9. The method of claim 5, wherein the EMCA system is deployed from/on a network via a software-deploying server.

10. The method of claim 5, wherein the EMCA system comprises logic for:
(a) providing an “insufficient funds” alert or an overdraft alert as a result of a service fee payment or chargeback payment to be debited from the Merchant's account; and
(b) providing the Merchant with access to a pre-authorized MCA from a Funder in response to an insufficient funds or overdraft alert.

11. The method of claim 5, wherein the EMCA system comprises logic for enabling the pre-authorized MCA to be automatically repaid by collecting a percentage of the Merchant's transaction receivables until an original payback amount, plus a flat fee, is received by the Funder.

12. The method of claim 5, wherein the EMCA system comprises logic for:
(a) detecting a debt event that includes: overdrafts, accounts about to overdraft, accounts low on funds, and/or accounts with insufficient funds, regardless of the type of account; and
(b) logic for generating an alert based on a debt event occurrence.

13. The method of claim 5, wherein the EMCA system comprises a merchant portal that provides an interface or link for an employee, owner, partner, member, officer, director, merchant, agent, contractor, computer with programmatic access, and/or a person and/or system and/or party authorized by the merchant, to log in and access a network or a server servicing the EMCA system.

14. The method of claim 5, wherein the EMCA system comprises a merchant portal that provides an interface or link to see the status of:
(a) any of the Merchant's accounts;
(b) the maximum MCA funding available;
(c) funds requests (including automatic and/or pre-approved funds, whether before or after an MCA is triggered for funding);
(d) requests for a funding amount lower than the maximum available;
(e) requests for increases or decreases in a maximum funding available,
(f) reviews of past MCA disbursements and/or repayments; and
(g) MCA repayments, including automatic repayments for the MCA funding.

15. The method of claim 14, wherein the merchant portal is provided by a financial institution system, a Merchant Servicer system, a server, a merchant system, and/or a third-party provider through a network or through the Internet.

16. The method of claim 14, wherein the merchant portal is configured to receive:
(a) business information;
(b) personal information;
(c) bank online access credentials, including one or more of the following: user name, password, email, code, second-factor authentication, biometric authentication, or digital certificate, and combinations thereof; and
(d) MCA and/or loan application information, files, or forms.

17. The method of claim 5, wherein the EMCA system comprises a computer network that allows the following items to be sent by a server:
(a) contract/agreement data;
(b) bank alerts;
(c) payback data; and
(d) MCA registrations/enrollments.

18. The method of claim 5, wherein the EMCA system determines an amount of funding that a merchant can receive; wherein the determination includes: underwriting, originating, sponsoring, an underwriting process, and origination process, and a sponsorship process.

19. The method of claim 14, wherein the merchant portal includes a virtual video Notary Public system wherein a Merchant can, through a video camera, scan and upload documents, cards, and any other image or content in the frame of the camera; and present the image or content as identification to the video notary; wherein the video Notary system including a microphone for capturing audio information; whereupon a notary authorization signal (NAS) is generated by a Notary Public based on reviewing and approving the video/audio input.

20. The method of claim 5, wherein the EMCA system is configured such that a Funder effectively buys a percentage of the Merchant's future receivables at a discount until a total payback amount is received by the Funder; wherein the total payback amount comprises the issued MCA amount plus fixed fee amount based on a factor rate, in lieu of charging interest on the MCA.

21. The method of claim 5, wherein the EMCA system comprises a funding analyzer module that analyzes a Merchant's transaction activities over a selected period of time to determine and recommend an ideal amount that the Funder can advance to the Merchant, given a particular flat fee or money factor rate and a specified term of the MCA.

22. The method of claim 5, wherein the EMCA funding is paid back automatically to the Funder with a percentage of future credit card transactions being applied to pay back the MCA.

23. The method of claim 5, wherein the EMCA system automatically triggers a pre-authorized MCA to cover non-payment of transaction-related service fees due to an insufficient funds account status; and wherein the system automatically alerts the MCA Funder about the MCA being issued.

24. The method of claim 5, wherein the EMCA system triggers issuance of an MCA to the Merchant when the Merchant incurs a chargeback that leads to an insufficient funds account status or an overdraft status.

25. The method of claim 5, wherein the EMCA system provides the Merchant Servicer a small share in a profit from the MCA advance.

26. The method of claim 5, wherein a percentage corresponding to a holdback is automatically triggered on the Merchant's credit card transactions.

27. The method of claim 5, wherein the Merchant Servicer automatically sends Merchant Service Statements to a Funder for a specified period, which enables the Merchant to be underwritten by the Funder for a much larger advance amount, without the Merchant having to provide financial statements.

28. The method of claim 27, wherein the Merchant Servicer receives a commission on a larger/additional advance of funding provided by the Funder to the Merchant.

29. The method of claim 27, wherein the EMCA system utilizes one or more algorithms that incorporate underwriting guidelines.

30. The method of claim 5, wherein the EMCA system operates without direct or indirect intervention of the Funder.
